(19) United States
(12) Patent Application Publication
(10) Pub. No.: US 2022/0036632 A1
(43) Pub. Date: Feb. 3, 2022

(54) POST-PROCESSING IN A MEMORY-SYSTEM EFFICIENT MANNER

(71) Applicant: Samsung Electronics Co., Ltd., Suwon-si (KR)

(72) Inventors: Raun M. KRISCH, Dripping Springs, TX (US); David C. TANNENBAUM, Austin, TX (US); Moumine BALLO, San Jose, CA (US); Keshavan VARADARAJAN, Austin, TX (US)

(21) Appl. No.: 17/187,729

(22) Filed: Feb. 26, 2021

Related U.S. Application Data
(60) Provisional application No. 63/060,657, filed on Aug. 3, 2020.

(51) Int. Cl. G06T 15/00; G06T 15/80; G06F 9/38; G06F 9/54

(52) U.S. Cl. CPC G06T 15/005; G06F 9/544; G06F 9/3877; G06T 15/80

(57) ABSTRACT

A GPU includes one or more post-processing controllers, and a 3D graphics pipeline including a post-processing shader stage following a pixel shader stage. The one or more post-processing controllers may synchronize an execution of one or more post-processing stages including the post-processing shader stage. The 3D pipeline may include one or more pixel shaders, one or more tile buffers, and a direct communication link between the post-processing shader stage and the one or more tile buffers. The one or more post-processing controllers may synchronize communication between the one or more post-processing shaders and the one or more tile buffers.

### RELATED APPLICATION DATA

This application claims the benefit of U.S. Provisional Application Ser. No. 63/060,657, filed on Aug. 3, 2020, which is hereby incorporated by reference.

### TECHNICAL AREA

The present disclosure relates to graphics processing units (GPUs), and more particularly, to post-processing in a memory-system efficient manner within a GPU.

### BACKGROUND

In Tile Based Deferred Rendering (TBDR) GPU architectures, substantial bandwidth and power savings may be achieved by rendering a scene in small, fixed sized tiles, which may fit entirely in an on-chip cache. At completion of a tile, the contents of the tile buffer may be written to main memory in preparation for the next tile to begin. Additionally, some TBDR architectures may maintain a “guard-band” around the tile buffer, which may include a few rows and/or columns of fragments from the neighboring tiles, and may sometimes be referred to as “padding.” A guard-band may be a collection of one or more rows and/or columns of additional pixels surrounding a tile, which may be redundantly computed, thereby allowing for neighborhood filtering operations, such as convolutions, to be performed at the boundaries of a tile while still processing tiles independently of one another. The term “guard-band” as used herein may be distinct from clipping.

An immediate mode rendering (IMR) GPU architecture may render the scene in the order the geometry is submitted to the pipeline, and need not rely on a tile buffer to reach its throughput goals. IMRs may have a standard hierarchical cache structure, which may benefit from temporal memory locality for increasing performance and lowering energy consumption. In contrast to IMR, TBDR architectures can have significant savings in bandwidth and power. However, post-processing algorithms, which may be used in real time 3D rendering, may often be skipped, or executed with reduced quality, on TBDR architectures. Because tiles may be flushed to memory automatically by the hardware, it may not be possible to perform a post-processing effect while still using the contents of the tile buffer using a conventional 3D rendering pipeline. Any attempt may cause a round trip of the desired data from the on-chip tile buffer cache, to memory, then back to a separate cache accessible to a pixel shader. This increases the number of input/output (I/O) operations, which reduces battery life of mobile devices that include the GPU.

Post-processing effects may use either simple fragment shaders or compute shaders to execute post-processing algorithms with reduced efficiency because hardware may not be able to keep data resident within the GPU's caches. Some graphics APIs have a construct called subpasses. In subpasses, a fragment location may read back the data for only the same location from the previous pass, which may make it less suitable for some algorithms, such as any sort of image processing algorithm making use of a neighborhood of fragments.

Alternative means may be used to achieve some degree of post-processing-like effects. For example, ambient occlusion can be pre-computed as an ambient occlusion texture map to be applied. An issue with this approach, however, is that the texture map may not reflect runtime changes in geometry. For example, a game engine (such as Unreal Engine® or other) may skip anti-aliasing for mobile builds (versus a laptop or a larger personal computer GPU), though it can be enabled with a fast approximate anti-aliasing (FXAA) unit. These alternatives to post-processing suffer from various quality limitations.

### BRIEF SUMMARY

Various embodiments of the disclosure include a GPU, comprising one or more post-processing controllers. The GPU may include 3D graphics pipeline including a post-processing shader stage following a pixel shader stage, wherein the one or more post-processing controllers is configured to synchronize an execution of one or more post-processing stages including the post-processing shader stage. The GPU may include one or more post-processing shaders, one or more tile buffers, and a direct communication link between the one or more post-processing shaders and the one or more tile buffers. In some embodiments, the GPU may have zero tile buffers in an IMR implementation. The one or more post-processing controllers is configured to synchronize communication between the one or more post-processing shaders and the one or more tile buffers.

Some embodiments disclosed herein include a method for performing post-processing in a GPU in a memory-system efficient manner. The method may include synchronizing, by one or more post-processing controllers, an execution of one or more post-processing stages in a three-dimensional (3D) graphics pipeline including a post-processing shader stage following a pixel shader stage. The method may include communicating, by a direct communication link, between one or more post-processing shaders and one or more tile buffers. The method may include synchronizing, by the one or more post-processing controllers, communication between the one or more post-processing shaders and the one or more tile buffers.

### BRIEF DESCRIPTION OF THE DRAWINGS

The foregoing and additional features and advantages of the present disclosure will become more readily apparent from the following detailed description, made with reference to the accompanying figures, in which:

FIG. 1A illustrates a block diagram of a GPU including a three-dimensional (3D) pipeline having a post-processing shader stage in accordance with some embodiments.

FIG. 1B illustrates a GPU including the 3D pipeline having the post-processing shader stage of FIG. 1A in accordance with some embodiments.

FIG. 1C illustrates a mobile personal computer including a GPU including the 3D pipeline having the post-processing shader stage of FIG. 1A in accordance with some embodiments.

FIG. 1D illustrates a tablet computer including a GPU having the 3D pipeline having the post-processing shader stage of FIG. 1A in accordance with some embodiments.

FIG. 1E illustrates a smart phone including a GPU having the 3D pipeline having the post-processing shader stage of FIG. 1A in accordance with some embodiments.

FIG. 2 is a block diagram showing a directed acyclic graph (DAG) associated with post-processing within a GPU in accordance with some embodiments.

FIG. 3 is a block diagram showing various components of a GPU including one or more post-processing controllers in accordance with some embodiments.

FIG. 4 is a flow diagram illustrating a technique for providing post-processing in a memory-system efficient manner in accordance with some embodiments.

### DETAILED DESCRIPTION

Reference will now be made in detail to embodiments disclosed herein, examples of which are illustrated in the accompanying drawings. In the following detailed description, numerous specific details are set forth to enable a thorough understanding of the inventive concept. It should be understood, however, that persons having ordinary skill in the art may practice the inventive concept without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first device could be termed a second device, and, similarly, a second device could be termed a first device, without departing from the scope of the inventive concept.

The terminology used in the description of the inventive concept herein is for the purpose of describing particular embodiments only and is not intended to be limiting of the inventive concept. As used in the description of the inventive concept and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

Some embodiments disclosed herein may comprise a GPU including a 3D pipeline having a post-processing shader stage. In addition, hardware scheduling logic may ensure efficient data accesses that reduce cache misses. Accordingly, performance may be improved, and energy consumption may be reduced, thereby extending the life of a battery within a mobile device.

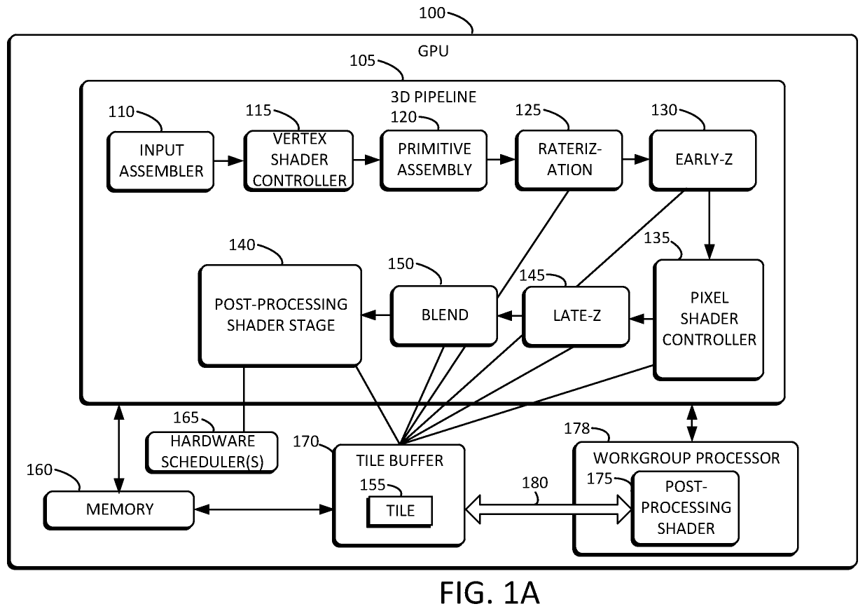

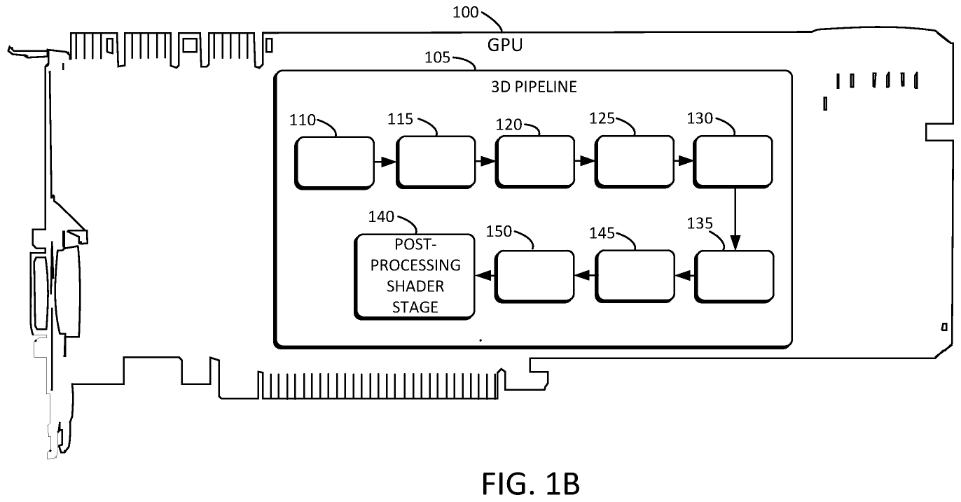

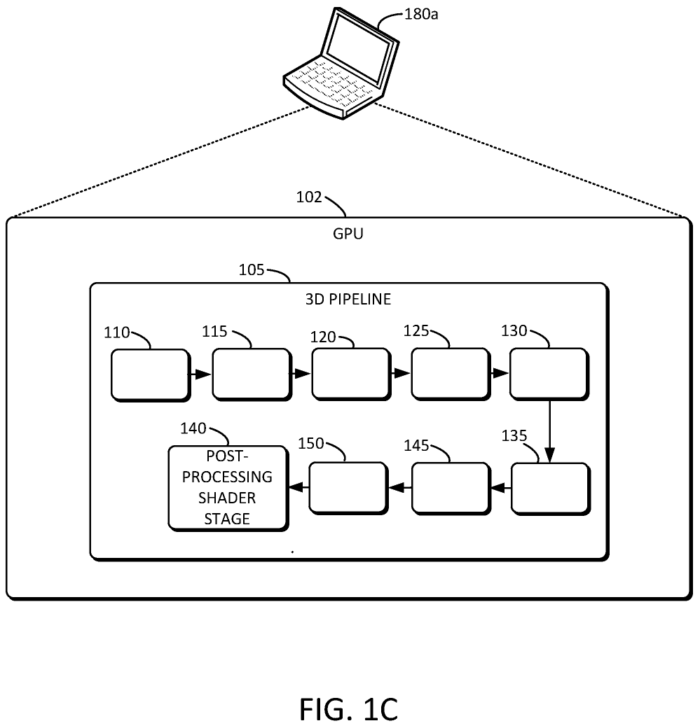

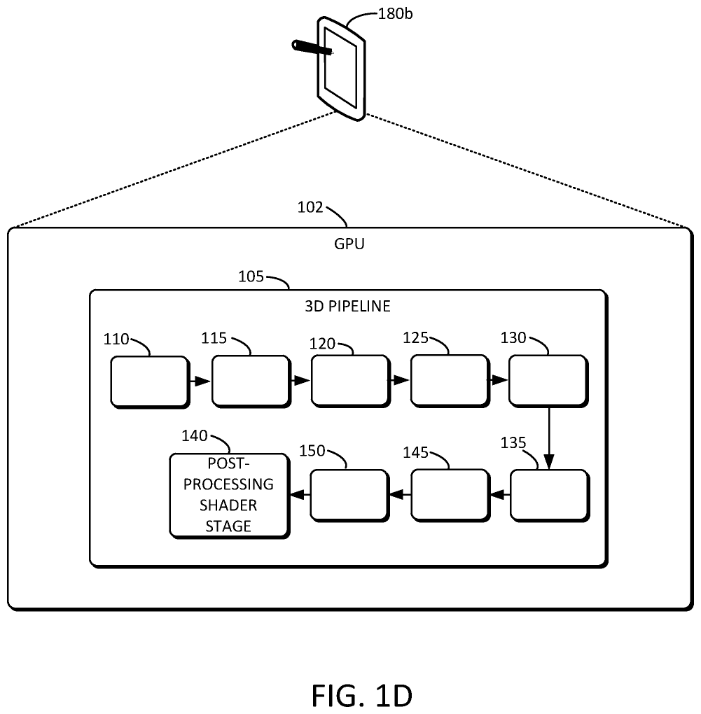

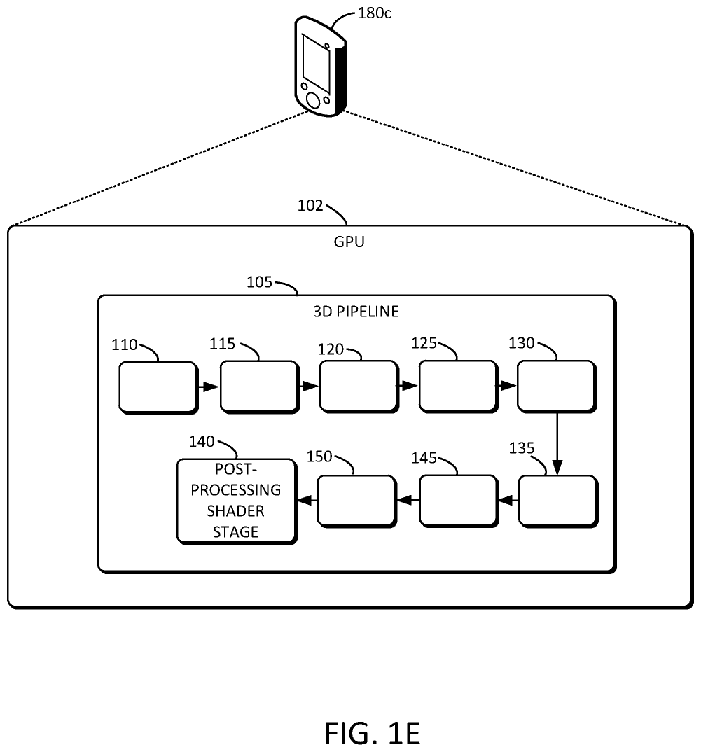

FIG. 1A illustrates a block diagram of a GPU 100 including a three-dimensional (3D) pipeline 105 having a post-processing shader stage 140 in accordance with some embodiments. The GPU 100 may include a memory 160. FIG. 1B illustrates a GPU 100 including the 3D pipeline 105 having the post-processing shader stage 140 of FIG. 1A in accordance with some embodiments. FIG. 1C illustrates a mobile personal computer 180a including a GPU 100 including the 3D pipeline 105 having the post-processing shader stage 140 of FIG. 1A in accordance with some embodiments. FIG. 1D illustrates a tablet computer 180b including the 3D pipeline 105 having the post-processing shader stage 140 of FIG. 1A in accordance with some embodiments. FIG. 1E illustrates a smart phone 180c including the 3D pipeline 105 having the post-processing shader stage 140 of FIG. 1A in accordance with some embodiments. Reference is now made to FIGs. 1A through 1E.

The memory 160 may include a volatile memory such as a dynamic random access memory (DRAM), or the like. The memory 160 may include a non-volatile memory such as flash memory, a solid state drive (SSD), or the like. The 3D pipeline 105 may include an input assembler stage 110, a vertex shader stage controller 115, a primitive assembly stage 120, a rasterization stage 125, an early-Z stage 130, a pixel shader stage controller 135, a late-Z stage 145, and/or a blend stage 150, or the like. The 3D pipeline 105 may be a real time 3D rendering pipeline, and may include the post-processing shader stage 140 following other stages of the 3D pipeline 105 in accordance with embodiments disclosed herein.

Embodiments disclosed herein may include a mechanism to augment the real time 3D rendering pipeline 105 to include the post-processing shader stage 140, which may be invoked automatically after rendering of a tile 155 is completed, but before contents of the tile 155 are flushed to the memory 160, thus enabling one or more post-processing effects to be performed efficiently and with minimal power usage. While embodiments disclosed herein may be most useful in TBDR architectures with a dedicated on-chip tile buffer, other architectures such as IMRs may also benefit through the use of a cache hierarchy. The post-processing shader stage 140 may operate on final rendered and blended fragment values (e.g., color, depth, and stencil) of a frame. Post-processing algorithms may be a key component in deferred rendering game engines, and may also be used to perform visual improvement effects such as depth of field, color correction, screen space ambient occlusion, among others.

The post-processing shader stage 140 may reduce memory traffic and/or expended energy. The post-processing shader stage 140 may depend on one or more hardware schedulers 165 to improve memory locality. The one or more hardware schedulers 165 may directly provide color, depth, stencil, and/or mask data automatically upon invocation to the post-processing shader stage 140, which may be executed on a workgroup processor 178, as further described below. When combined with the one or more hardware schedulers 165, significant performance savings can be achieved for post-processing algorithms. The post-processing shader stage 140 may expose the following data to an application developer: i) an existence of an on-chip tile buffer, ii) an absence of the on-chip tile buffer, and/or iii) a size of any guard-band around the tile buffer. The post-processing shader stage 140 may provide a direct, efficient physical (e.g., hardware) connection 180 between a tile buffer 170 and a post-processing shader 175, as further described below. The post-processing shader stage 140 may have the benefit of the direct, efficient hardware interface 180 to the tile buffer 170. For IMR architectures, the post-processing shader stage 140 may provide a direct, efficient physical (e.g., hardware) connection between a cache used for render targets and the post-processing shader 175. The post-processing shader 175 may be a process that is executed by a workgroup processor 178. The workgroup processor 178 may be a shader core array, for example.

The post-processing shader 175 may provide one or more additional inputs to warp scheduling (e.g., arbitration), to graphics processing, and/or post-processing warps. The post-processing shader stage 140 may provide a description of dependencies for post-processing shader stages associated with and/or readable by the one or more hardware schedulers 165. The post-processing shader stage 140 may make one or more formats directly hardware accessible.

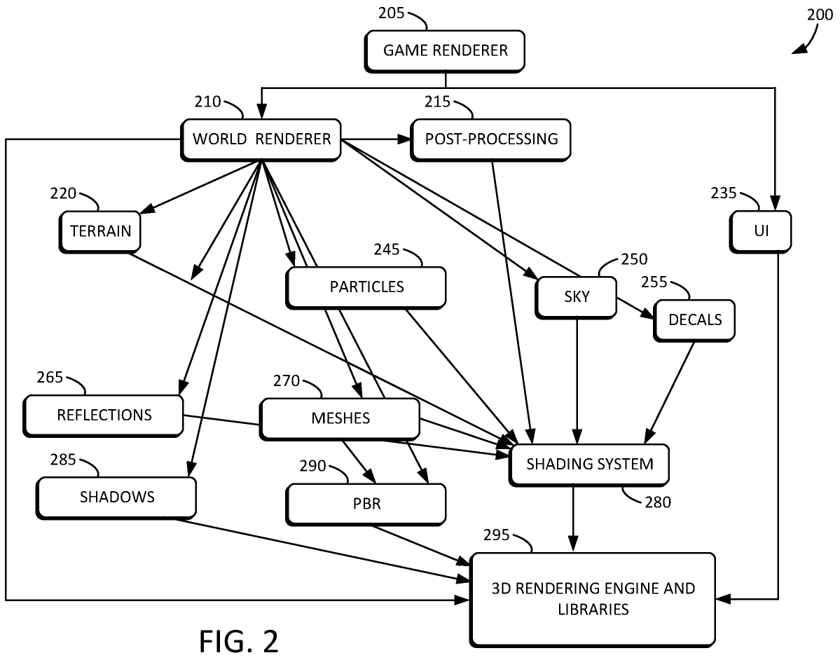

FIG. 2 is a block diagram showing a directed acyclic graph (DAG) 200 associated with post-processing within a GPU (e.g., 100 of FIG. 1) in accordance with some embodiments. The DAG 200 may include various post-processing components, aspects, and/or stages. The DAG 200 may include a game renderer 205. The DAG 200 may include a 3D rendering engine and associated libraries 295. The DAG 200 may include a user interface (UI) 235. The DAG 200 may include various components, aspects, and/or stages such as a world renderer 210, terrain 220, particles 245, reflections 265, meshes 270, shadows 285, and/or physically based rendering (PBR) 290. The DAG 200 may include post-processing 215, sky 250, decals 255, and/or a shading system 280.

The graphics processing pipelines described by various graphics standards may be simplistic and may not capture the complexity of a multi-pass nature of processing employed by modern game engines. Modern game engines may use several post-processing steps as shown in FIG. 2. Graphics architectures may be optimized for the simplistic pipelines expressed by the standards with some awareness of render passes. However, the complex dependency chains may not be considered, while instead the pipelines may be optimized for performance, power, or area with regards to older graphics streams. This disclosure may address these and other limitations through pass dependence-aware scheduling of render passes.

Generally, graphics rendering has a few different types of processing. Geometry processing and pixel shading passes may include many draw calls and considerable associated geometry. An example of this kind of a pass is G-Buffer pass in which base geometry is rendered into an intermediate buffer. Lighting passes may have very few triangles and modify pixel values generated previously, such as during an earlier G-Buffer pass. Pixel processing passes may have no geometry associated with them and may be used to modify previously generated pixels. Examples of a pixel processing pass include motion blur, bloom, or the like.

Both lighting passes and pixel processing passes may be referred to as post-processing stages. Embodiments disclosed herein can apply to both of these kinds of passes. The various I/0s provided to the post-processing stages, and the overall scheduling of work, may be dependent on the behavior of a game engine and application processing. Multiple post-processing effects may be chained together, forming a pipeline. These various stages may form a simple pipeline (different from the 3D pipeline 105 described above) or, more generally, the DAG 200 as shown in FIG. 2. Game engines may typically process a whole DAG 200 as a render-graph in order to build a particular frame. The render-graph may record all passes and their resources. The scheduling, synchronization, and resource transitions may then be optimized for the whole pass to minimize stalls and share intermediate computation results. Embodiments disclosed herein include a further optimization of the render-graph execution.

Various stages of the DAG 200 may involve data reduction or transformation, such as filtering for the depth-of-field effect. While some of the image processing effects, like gaussian blur, may be more likely to use smaller kernels and therefore a smaller guard-band, others like screen space ambient occlusion or screen space reflections may use a wider neighborhood surrounding the current pixel and perform dozens of reads per pixel of computation. Dependencies between source fragment and resultant fragments may be known. This information can be used to perform i) software optimizations to merge multiple shaders, and/or ii) scheduling optimizations to minimize memory traffic.

Post-processing pixel dependencies may be 1:1 between various stages. When the dependencies are 1:1 and the distance between dependent pixels is zero, then it is possible to create a compiler-like software, which may merge these post-processing shader stages into a single kernel. However, the dependencies may not have these properties, i.e., either i) the resultant pixel is dependent on more than one other pixel, or ii) the distance of at least one of these pixels may be non-zero. A resultant pixel (x, y) may be dependent on another pixel (p, q) where x≠p and/or y≠q). In some embodiments, the shader stages need not be merged, or cannot conveniently be merged, and they may be scheduled in sequence.

Use of interleaving and caching mechanisms in the post-processing stage can benefit the efficiency of computing these effects. In the tiled-based rendering context, interleaving may become more feasible with the possibility of tiles moving independently along the render-graph DAG 200, and may be constrained by shared guard-band usage. Effects without need of a guard-band, such as tone-mapping, can process tiles fully independently.

For some image processing effects, shaders may include passes that reduce the size of the image in each pass. To accommodate such scenarios, as input, embodiments disclosed herein may consume dependency information for each pass regarding accessed fragments in the source image(s). Thus, minimization or maximization algorithms can benefit from embodiments disclosed herein. However, when a stage's shader(s) output is a different sized image compared to the input image (e.g., minimization or maximization is present), an implementation may choose to break the tile interleaving of shaders in the pipeline and run a shader (e.g., computing a pipeline stage) to completion or run multiple tiles in a pipeline stage to completion before executing a tile from a subsequent shader in the pipeline. When this happens, functional correctness may be maintained, but efficiency may be reduced from what could otherwise be achieved by embodiments disclosed herein.

Following are different kinds of passes in a given frame rendering in a rendering engine for deferred rendering.
Render to a particle buffer (e.g., renders particle parameters into a buffer to be processed later).
Render depth Z-pre-pass (e.g., renders opaque geometries into a depth buffer to be used for hierarchical Z (HiZ) and shadows).
Compute light grid (e.g., build a 3D grid to segregate lights for optimal lighting).
Begin occlusion tests.
Build hierarchical Z.
Render shadow depths (e.g., build shadow maps from shadow casting lights).
Compute volumetric fog (e.g., 3D fog texture).
Render decals (e.g., build decal buffers).
Render GBuffer (e.g., renders geometric and material properties into Gbuffer).
Screen space ambient occlusion.
Lighting.
Screen space reflection (SSR)+temporal antialiasing (TAA) (e.g., computes screen space reflection and anti-aliases them).
Environment reflection+Skybox.
Exponential height fog.
Render particles.
Render translucency.

In addition, various post-processing effects can be performed, such as the following:
Render distortion.
Post-processing (e.g., full frame).
   a. Depth of field.
   b. Motion blur.
   c. Eye adaptation.
   d. Downsample.
   e. Bloom.
   f. Tonemap.
   g. Fast approximate anti-aliasing (FXAA) (e.g., post-processing anti-aliasing).
   h. Post-processing anti-aliasing (e.g., FXAA).

Technically, all screen space effects may be post-processing effects. Additional post-processing effects may include sun rays (e.g., Godrays), color grading, heat waves, heat signature, sepia, night vision, sharpen, edge detection, segmentation, and/or bilateral filtering, or the like.

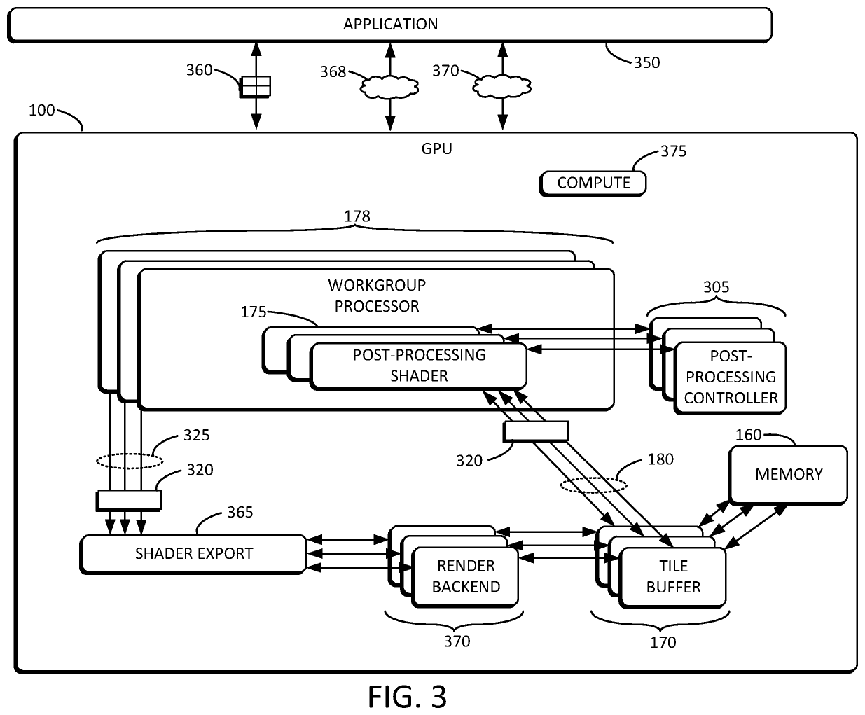

FIG. 3 is a block diagram showing various components of a GPU (e.g., 100 of FIG. 1) including one or more post-processing controllers 305 in accordance with some embodiments. The one or more post-processing controllers 305 may execute the post-processing shader stage (e.g., 140 of FIG. 1). Reference is now made to FIGS. 1 and 3.

Embodiments disclosed herein include performing post-processing in the GPU 100 in a memory-system efficient manner. Embodiments disclosed herein may include synchronizing, by one or more post-processing controllers 305, an execution of one or more post-processing stages 140 in the 3D graphics pipeline 105 including a post-processing shader stage 140 following a pixel shader stage controller 135.

Embodiments disclosed herein may include an interface 180 (e.g., bus) between one or more post-processing shaders 175 and one or more tile buffers 170. For IMR architectures, a memory cache or other suitable memory interface may be used to facilitate communication between the one or more post-processing shaders 175 and the memory 160. Additionally, a new control structure 320 may be provided to perform arbitration and/or interlock between the one or more post-processing shaders 175 and the one or more tile buffers 170.

Embodiments disclosed herein may include the one or more post-processing controllers 305 in the 3D pipeline 105. The one or more post-processing controllers 305 may schedule dependent post-processing shaders 175 one after another. The post-processing shader stage 140 (e.g., of FIG. 1) may include the following properties. The one or more post-processing controllers 305 may execute similar to a “compute shader” with a 2D dispatch size equal to the tile (e.g., 155 of FIG. 1) or tile+guard-band dimensions. The one or more post-processing shaders 175 may fetch data from any fragment contained within the tile (e.g., 155 of FIG. 1). The one or more post-processing shaders 175 may use a data link 180 (e.g., bus) between one or more workgroup processors 178 and one or more tile buffers 170. The one or more post-processing controllers 305 may use the data link 325 by way of a shader export 365 and/or one or more render backends 370. The date link 180 is advantageous because it enables the post-processing shaders 175 that run on the workgroup processors 178 to directly access the pixel and/or fragment data they may need in the tile buffer 170.

In an IMR, in lieu of the tile buffer 170, a portion of the memory 160 may be a high-performance cache that is tightly-coupled to the Late-Z 145 and blend stage 150, and also tightly-coupled to the post-processing shader stage 140, and thus in terms of hardware, tightly-coupled to the one or more post-processing shaders 175.

An application 350 can query one or more properties of the post-processing shader stage 140. The one or more post-processing controllers 305 may interface with the application 350. The application 350 can query a tile size (i.e., dimensions in terms of pixels), and receive the tile size from the GPU 100. The application 350 can query a size of a “guard-band” for top, left, bottom, and right edges of the tile (e.g., 155 of FIG. 1), and receive the size of the “guard-band” from the GPU 100. The application 350 may provide for execution of a shader program as a post-processing shader 175 in the workgroup processor 178. The shader program can query a provoking fragment coordinate of the tile (e.g., 155 of FIG. 1), represented by any of the 4 corners of the tile, and receive the provoking fragment coordinate from the GPU 100. During shader operation, the shader program may query for various provoking pixel information. The driver may query for more static information such as an amount of guard band, and may use these query responses in determining the appropriate shader program code to use in the post-processing shader(s) 175.

The application 350 may provide an active fragment mask (AFM) 360 to the post-processing shader stage 140. The application 350 may provide one or more control signals 368 to direct the hardware to generate one or more values (e.g., color, depth, stencil, normal vectors, AFM, or any other interpolated attribute), which may be provided to the one or more post-processing shaders 175 upon launch. The application 350 may provide one or more hints 370 regarding which sides of the guard-band are going to be used (top, left, bottom, and/or right edges).

The one or more post-processing controllers 305 can have one or more inputs and outputs. When a post-processing shader stage 140 is launched, one or more post-processing controllers 305 can provide a color of a fragment to the one or more post-processing shaders 175 automatically upon launch. Additionally, a coordinate (e.g., X, Y) of the fragment's location, the fragment's depth value, and the fragment's stencil value can be provided to the one or more post-processing shaders 175 automatically as well. In order to determine the bounds of the current work tile 155 and facilitate accessing neighboring fragments, a provoking fragment coordinate can be provided to the one or more post-processing shaders 175 automatically as well.

During the post-processing shader stage 140, an invocation may fetch the color, depth, and stencil value of any other fragment within the tile 155 and guard-band with the intent of performing post-processing algorithms on rendered images. In order to keep consistency of the data in the one or more tile buffers 170, an implementation may choose to use hardware scheduling of writes-back to the one or more tile buffers 170, and/or rely on the one or more post-processing shaders 175 performing synchronization through traditional mutex (e.g., a mutual exclusion preserving construct), semaphore, and/or barrier techniques.

The active fragment mask 360 may inform the post-processing shader pipeline of which neighboring fragments are accessible from an invocation of the post-processing shader. This may be designed to exclude fragments, which may be known to not need post-processing. Additionally, the traditional fragment shading stage of the 3D pipeline 105 may compute a post-processing active fragment mask dynamically. The post-processing shader stage 140 may automatically invert the active fragment mask 360 after the fragment stage completes, but before the post-processing shader stage 140 executes.

In regard to providing proper synchronization of pixel fetch data from, and return to, the one or more tile buffers 170, the active fragment mask 360 may be extended to provide a multi-bit “state” for each pixel in the one or more tile buffers 170, which may be used to convey such information as “locked” or “updated,” and whose exact meaning may be left to the discretion of the application 350. An embodiment may make these state bits available to the scheduler(s) 165 to avoid scheduling a warp in which some pixels may be locked. The alternative may include having a spin loop within the one or more post-processing shaders 175, but this may be both energy and performance inefficient. These state bits may be reset to a known value upon initiating the first post-processing shader stage 140.

The value of having an explicit post-processing shader stage 140 as part of the 3D pipeline 105 may include giving hardware schedulers 165 the ability to interleave completing the fragment shader and following post-processing shader stage 140 on a tile 155 for TBDR rendering architectures to improve performance and reduce energy consumption. Similarly, on other architectures, including IMR architectures, interleaving can still be beneficial when balanced with cache sizes. Additionally, when guard-band fragments may be requested by the post-processing shader stage 140, a TBDR renderer can reorder the sequence of rendered tiles to naturally retain the necessary fragments in the tile buffer. For example, when requesting right and bottom edge guard-band fragments, a scheduler 165 may choose to render tiles 155 from the top left to the bottom right in a cascading pattern to reduce the need of fetching as many guard-band fragments from memory 160 in lieu of obtaining these fragments from the tile buffer 170. Since the post-processing shader stage 140 can be enabled or disabled, there may be no performance loss when the stage is not needed by the pipeline.

Embodiments disclosed herein may include an extension to the 3D graphics pipeline 105, allowing for a post-processing shader stage 140 to run immediately following completion of the pixel shader and blending operations. The one or more post-processing controllers 305 may have access to all data within an array of pixels (e.g., a tile or tile+guard-band worth of information), including new buses and/or interfaces (e.g., 180) to connect the one or more post-processing shaders 175 to the one or more tile buffers 170. Embodiments include a synchronization mechanism to schedule execution of post-processor warps in the one or more post-processing shaders 175. Embodiments disclosed herein may be tuned to maximize cache locality with respect to data written by pixel shaders responsive to the one or more pixel shader controllers 135 and processed by optional lateZ 145 and optional blend 150, and later consumed by the one or more post-processing shader stages 140.

The data produced and/or written by pixel shaders responsive to the one or more pixel shader controllers 135 may be later consumed by the one or more post-processing shaders 175 responsive to post-processing controllers 305. Accordingly, as much data as possible can remain in situ within the one or more tile buffers 170 between the completion of the pixel shaders responsive to the pixel shader controllers 135 and the commencement of the post-processing controllers 305 setting up for consumption of these data by the post-processing shaders 175.

Synchronization mechanisms to prevent the post-processing of one pixel to update data prior to original data value(s) being available and consumed by other pixels in the one or more post-processing controllers 305 may be used. Operations in the post-processing controller 305 may be controlled by the mask 360.

Embodiments disclosed herein may also be applicable to compute shaders 375, also executed on workgroup processor 178. The compute shaders 375 may be constructed as a hierarchy of work divisions. For example, an N-dimensional range (e.g., NDRange) of an entire N-dimensional grid of work to perform may be part of such a hierarchy. Workgroups may also be N-dimensional grids, but may be a subset of the larger NDRange grid.

By assigning each fragment to a thread in the compute shader 375, similar gains in power and performance can be achieved. The active thread mask 360 may inform the post-processing shader pipeline of which neighboring fragments are accessible from an invocation of the post-processing shader. An active workgroup, as masked by a mask 360 may include data accesses, by threads in a workgroup that fall outside of any thread in the workgroup's unique global ID. The mask 360 may include threads in a workgroup that share data through the tile buffer 170, and when data is shared across different workgroups through the memory 160. This usage pattern may allow workgroups from different NDRanges to be interleaved at the workgroup granularity. When the data sharing/exchange is within the workgroup, and within the tile buffer 170 extent, then the data can be interchanged more locally within the tile buffer 170. However, when the data is to be interchanged and/or exchanged with a thread beyond the current workgroup ID, the memory 160 (i.e., a more distant, and thus more energy intensive mechanism) may be used.

Similarly, some GPU programming models may expose subgroups. A subgroup may include a group of threads executing simultaneously on a compute core. Subgroups may contain 8, 16, 32, or 64 threads, for example. An active subgroup mask may include data accesses, which threads in a workgroup may perform that fall outside of any thread in the workgroup's unique global ID.

Some of the advantages of the embodiments disclosed herein include increases in the performance, and a lowering of energy consumption of 3D rendered graphics post-processing effects. Improvements may be made to depth of field, color correction, tone mapping, and/or deferred rendering. By giving the one or more post-processing shaders 175 both read and write access to the one or more tile buffers 170, all of the features and/or functionality of the one or more tile buffers 170 may now be made available to post-processing. One or more compression techniques may be applied upon flushing the one or more tile buffers 170 to memory 160. Embodiments disclosed herein may provide higher bandwidth—the one or more tile buffers 170 may be multi-banked to allow for a high multiplicity of I/O ports. Data associated with post-processing can be written to the memory 160 in various formats, such as block linear or row linear. The one or more tile buffers 170 and the memory system 160 may perform read and/or write operations that are optimized block accesses, and provide a lower-energy path relative to a comparable number of bytes' worth of compute-shader style loads and stores.

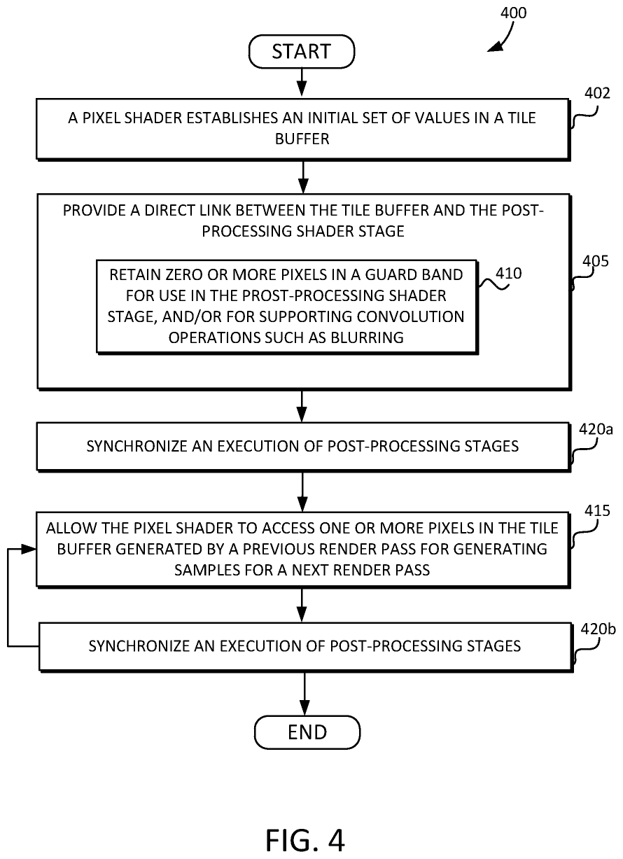

FIG. 4 is a flow diagram 400 illustrating a technique for providing post-processing in a memory-system efficient manner in accordance with some embodiments. At 402, a pixel shader may establish an initial set of values in a tile buffer. At 405, a direct link may be provided between the tile buffer and the one or more post-processing shaders. The contents of a recently-completed pixel shader may be retained, i.e., the contents are not flushed to memory. At 410, zero or more pixels may be retained in a guard band for use by the post-processing shader stage, and/or for supporting, for example, convolution operations such as blurring. At 420a, one or more post-processing controllers may synchronize an execution of post-processing stages. At 415, the post-processing shader(s) may be allowed to access one or more pixels in the tile buffer generated by a previous render pass for generating samples for a next render pass. At 420b, one or more post-processing controllers may synchronize an execution of post-processing stages. The flow may return from 420b to 415 and iterate steps 415 and 420b to perform more than one post-processing step. It will be understood that the steps of FIG. 4 need not be performed in the order shown, and intervening steps may be present.

The blocks or steps of a method or algorithm and functions described in connection with the embodiments disclosed herein may be embodied directly in hardware, in a software module executed by a processor, or in a combination of the two. Modules may include hardware, software, firmware, or any combination thereof. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

The following discussion is intended to provide a brief, general description of a suitable machine or machines in which certain aspects of the inventive concept can be implemented. Typically, the machine or machines include a system bus to which is attached processors, memory, e.g., RAM, ROM, or other state preserving medium, storage devices, a video interface, and input/output interface ports. The machine or machines can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines can include embedded controllers, such as programmable or non-programmable logic devices or arrays, ASICs, embedded computers, cards, and the like. The machine or machines can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth®, optical, infrared, cable, laser, etc.

Embodiments of the present disclosure can be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the present disclosure with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the inventive concept” or the like are used herein, these phrases are meant to generally reference embodiment possibilities, and are not intended to limit the inventive concept to particular embodiment configurations. As used herein, these terms can reference the same or different embodiments that are combinable into other embodiments.

Embodiments of the present disclosure may include a non-transitory machine-readable medium comprising instructions executable by one or more processors, the instructions comprising instructions to perform the elements of the inventive concepts as described herein.

The foregoing illustrative embodiments are not to be construed as limiting the inventive concept thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this present disclosure as defined in the claims.

What is claimed is:

1. A graphics processing unit (GPU), comprising:
one or more post-processing controllers; and
a three-dimensional (3D) graphics pipeline including a post-processing shader stage following a pixel shader stage, wherein the one or more post-processing controllers is configured to synchronize an execution of one or more post-processing stages including the post-processing shader stage.

2. The GPU of claim 1, further comprising:
one or more post-processing shaders;
one or more tile buffers; and
a direct communication link between the one or more post-processing shaders and the one or more tile buffers.

3. The GPU of claim 2, wherein the one or more post-processing controllers is configured to synchronize communication between the one or more post-processing shaders and the one or more tile buffers.

4. The GPU of claim 2, wherein the one or more post-processing shaders have access to one or more pixels from the one or more tile buffers.

5. The GPU of claim 4, wherein the one or more pixels accessed by the one or more post-processing shaders are generated by a previous render pass for generating samples for a next render pass.

6. The GPU of claim 4, wherein the one or more pixels are configured to be retained in a guard band residing in the one or more tile buffers responsive to the one or more post-processing controllers.

7. The GPU of claim 6, wherein the retained one or more pixels are configured to support one or more convolution operations.

8. The GPU of claim 4, wherein the one or more post-processing controllers is configured to retain zero pixels in a guard band.

9. A method for performing post-processing in a graphics processing unit (GPU) in a memory-system efficient manner, comprising:
synchronizing, by one or more post-processing controllers, an execution of one or more post-processing stages in a three-dimensional (3D) graphics pipeline including a post-processing shader stage following a pixel shader stage.

10. The method of claim 9, further comprising communicating, by a direct communication link, between the one or more post-processing shader stages and one or more tile buffers.

11. The method of claim 10, further comprising synchronizing, by the one or more post-processing controllers, communication between the one or more post-processing shader stages and the one or more tile buffers.

12. The method of claim 10, further comprising providing access to the one or more post-processing shader stages to one or more pixels from the one or more tile buffers.

13. The method of claim 12, wherein the one or more pixels accessed by the one or more post-processing shader stages are generated by a previous render pass for generating samples for a next render pass.

14. The method of claim 12, further comprising, retaining, by the one or more post-processing controllers, the one or more pixels in a guard band.

15. The method of claim 14, further comprising supporting one or more convolution operations using the retained one or more pixels.

16. The method of claim 12, further comprising, retaining, by the one or more post-processing controllers, zero pixels in a guard band.

17. The method of claim 9, further comprising, querying, by an application, one or more properties of the one or more post-processing shader stages.

18. The method of claim 17, further comprising:
querying, by the application, a tile size; and
receiving, by the application, the tile size.

19. The method of claim 9, further comprising, interfacing, by the one or more post-processing controllers, with the application.
